(19) United States
(12) Patent Application Publication
(10) Pub. No.: US 2021/0072784 A1
(43) Pub. Date: Mar. 11, 2021

(54) OPTICAL NONLINEARITY AND AMPLIFICATION DEVICES FOR OPTICAL NEURAL NETWORKS

(71) Applicant: Intel Corporation, Santa Clara, CA (US)

(72) Inventors: Wenhua Lin, Fremont, CA (US); Haisheng Rong, Pleasanton, CA (US); Jin Hong, Saratoga, CA (US)

(21) Appl. No.: 16/950,815

(22) Filed: Nov. 17, 2020

(51) Int. Cl. G06E 3/00; G02F 1/225; G06N 3/04

(52) U.S. Cl. CPC G06E 3/005; G06N 3/04; G06E 3/008; G02F 1/225

(57) ABSTRACT

Embodiments of the present disclosure describe techniques and configurations for a nonlinear optical device used to construct an optical neural network (ONN) with an arbitrary number of layers of matrix multipliers. The nonlinear optical device includes a waveguide to receive optical input and a gain medium coupled with the waveguide, to amplify or attenuate the received optical input, to provide an output that is amplified in a nonlinear manner in response to the optical input reaching saturation, where the nonlinearly amplified output is to provide a nonlinear activation function for an ONN. Additional embodiments may be described and claimed.

### FIELD

Embodiments of the present disclosure generally relate to the field of optoelectronics, and more particularly, to techniques and configurations for an optical matrix multiplier for optical neural networks.

### BACKGROUND

Machine learning architectures are typically based on artificial neural networks (ANNs). Optical neural networks (ONNs) are a type of physical implementation of artificial neural network (ANN) that use optical components as a building blocks. The basic building blocks of an optical neural network (ONN) typically include interconnected Mach-Zehnder interferometers (MZI) that perform unitary transformations on an array of optical signals. However, due to the size and configuration of MZIs, a network of interconnected MZIs may be less compact than desired. Furthermore, ANN computations typically implement nonlinear functions (such as Rectified Linear Unit ReLu, Sigmoid S-shape, Tan h, or threshold step-like functions), in addition to the linear algebra matrix computations. However, in optical domain, there appear to be no equivalent optical nonlinear activation functions and/or devices for ONN.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings.

FIG. 1 is a context diagram that shows a nonlinear optical device within a layer of an ONN, in accordance with various embodiments.

FIG. 2 illustrates examples of a nonlinear optical device with and without a carrier injection forward biased diode, in accordance with various embodiments.

FIG. 3 illustrates a graph with example input and output power characteristics of an optical nonlinear device of FIG. 2, in accordance with various embodiments.

FIG. 4 illustrates various diagrams of an example nonlinear optical device, in accordance with various embodiments.

FIGS. 5A and 5B illustrate examples of forward bias and reverse bias effects applied to a nonlinear optical device, in accordance with various embodiments.

FIG. 6 illustrates various example diagrams of a carrier injection forward based diode used in a nonlinear optical device, in accordance with various embodiments.

FIG. 7 illustrates an example matrix multiplier that includes a plurality of 2×2 unitary directional optical matrices and an optical unitary matrix that includes a plurality of 2×2 unitary multi-mode interference (MMI) optical couplers, in accordance with other embodiments of the present disclosure.

FIG. 8 illustrates an example computing device provided with an ONN in accordance with various embodiments.

### DETAILED DESCRIPTION

Embodiments of the present disclosure describe techniques and configurations for a nonlinear optical device used to construct an optical neural network (ONN) with one or more layers of matrix multipliers. Embodiments include coupling the nonlinear optical device to the outputs of the layers comprising optical coherent matrix multipliers to apply amplification, attenuation, and nonlinearity functions. In embodiments, the nonlinear optical device includes a waveguide to receive optical input and a gain medium coupled with the waveguide, to amplify the received optical input, to provide an output that is amplified in a nonlinear manner in response to the optical input reaching saturation, where the nonlinearly amplified output is to provide a nonlinear activation function for an ONN.

In embodiments, the nonlinear optical device provides optical amplification to compensate for waveguide propagation loss needed to emulate the multiple layers of the ONN. In embodiments, a III-V gain medium is bonded to silicon photonics to provide amplification, where the gain medium provides a linear amplification, and a nonlinear amplification function in response to the input power reaching a saturation level. In embodiments, a carrier-injection PIN diode can be added to couple with the amplification function to provide light attenuation control to not overload the subsequent layer or photodiode array (PDA).

In the following description, various aspects of the illustrative implementations will be described using terms commonly employed by those skilled in the art to convey the substance of their work to others skilled in the art. However, it will be apparent to those skilled in the art that embodiments of the present disclosure may be practiced with only some of the described aspects. For purposes of explanation, specific numbers, materials, and configurations are set forth in order to provide a thorough understanding of the illustrative implementations. However, it will be apparent to one skilled in the art that embodiments of the present disclosure may be practiced without the specific details. In other instances, well-known features are omitted or simplified in order not to obscure the illustrative implementations.

In the following detailed description, reference is made to the accompanying drawings that form a part hereof, wherein like numerals designate like parts throughout, and in which is shown by way of illustration embodiments in which the subject matter of the present disclosure may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B, and C).

The description may use perspective-based descriptions such as top/bottom, in/out, over/under, and the like. Such descriptions are merely used to facilitate the discussion and are not intended to restrict the application of embodiments described herein to any particular orientation.

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

The term “coupled with,” along with its derivatives, may be used herein. “Coupled” may mean one or more of the following. “Coupled” may mean that two or more elements are in direct physical or electrical contact. However, “coupled” may also mean that two or more elements indirectly contact each other, but yet still cooperate or interact with each other, and may mean that one or more other elements are coupled or connected between the elements that are said to be coupled with each other. The term “directly coupled” may mean that two or more elements are in direct contact.

As used herein, the term “optical waveguide” can refer to any physical device or structure that guides light (e.g., an optical signal) in a confined manner. In embodiments, the optical waveguides include silicon-based optical waveguides having a core for confinement of light and formation of modes surrounded by a cladding or substrate, having a lower refractive index than the core.

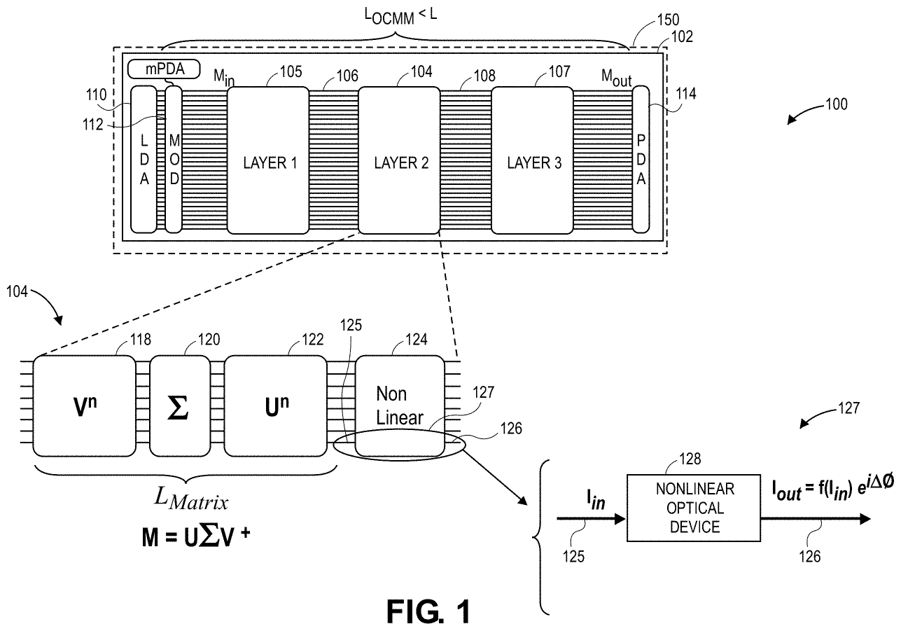

FIG. 1 is a context diagram that shows a nonlinear optical device within a layer of an ONN, in accordance with various embodiments. FIG. 1 illustrates an example integrated photonic device 100 that comprises an ONN 102 that includes one or more layers 104 having multiple optical signal inputs 106 and multiple optical signal outputs 108. In this example, each layer 104 has 32 optical signal inputs 106 and 32 optical signal outputs 108. In other embodiments the number of optical signal inputs 106 or optical signal outputs 108 may vary. In embodiments, the ONN 102 may be provided as an integrated circuit on the integrated photonic device 100.

Within the ONN 102, a laser diode array (LDA) 110 together with optical modulators 112 (hereinafter referred to as “modulator 112”) provides optical input to a first layer 105. A photodetector array 114 will receive optical output from the third layer 107, and convert that output into digital signals. In this example, light signals are sent from layer 1 105, to layer 2 104, and then to layer 3 107. Each layer is made up of an optical unitary matrix multiplier (that may include a plurality of optical unitary matrix multipliers) and non-linear optical devices (e.g., nonlinear optical amplifiers 124 described below). In embodiments, the ONN 102 including array (LDA) 110, modulator 112, multiple layers 105, 104, 107, and PDA 114 can be implemented in a heterogeneously integrated photonics circuit, such as a single silicon photonics die or single semiconductor substrate 150.

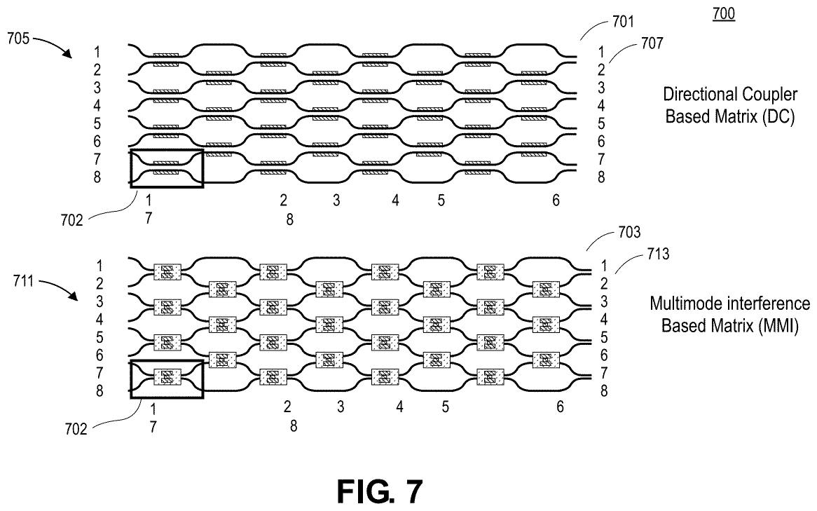

FIG. 1 provides a blown-up view of layer 2 104, to show various components of the optical unitary matrix multiplier unit within the layer. As shown, layer 2 104 includes three optical unitary matrix multipliers 118, 120, 122 that are composed of a plurality of optical unitary matrices (not shown), coupled together as described with respect to FIG. 7 below. As shown, as the light signals flow out of the Uⁿ optical unitary matrix multiplier 122 and into a plurality of nonlinear optical amplifiers 124 for each layer 104.

Nonlinear optical amplifiers 124 may be needed to be coupled to the optical unitary matrix multiplier 122 due to the linear nature of the optical signal processing from the optical unitary matrix multipliers 118, 120, 122. The optical signal, including noise added to the optical signal, may be linearly increased during operation of the ONN 102, and may result in a final signal intensity from the Uⁿ optical unitary matrix multiplier 122 that is too high. This signal intensity may cause optical inputs to overload a subsequent layer 107, or overload the PDA 114.

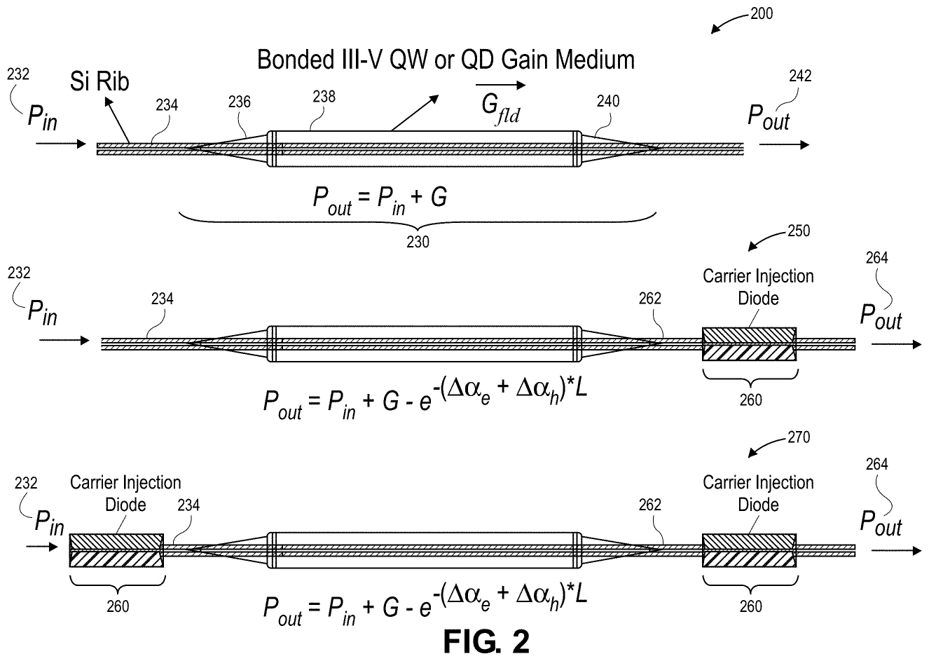

The nonlinear optical amplifier 124 may comprise multiple nonlinear optical devices. An example nonlinear optical device 128 shown in FIG. 1 to the right of the layer 104 (blown-up area 127 of the nonlinear amplifier 124). An optical input signal 125 into the device 128 may be transformed into an optical output signal 126 of a particular nonlinear optical device 128 shown with respect to area 127. The term “amplifier” is used in a broad sense here. The input signal 125 may need to be amplified in a linear way, amplified in a non-linear way, as well as saturated and attenuated, and/or otherwise “cleaned up” in order for the resulting optical signal output 126 to be more distinguishable. Other functions may include light rectifying and saturating for the resulting optical signal output for high classification and predication in the ONN layers. These functions are explained further in reference to FIG. 2.

The equation I out=f(Iᵢₙ)e^{iΔϕ} on the output of 126 shown in FIG. 1 defines the overall optical signal input to optical signal output nonlinear activation function, where f is the optical intensity function of nonlinear optical device 128 as a function of optical signal input power Iᵢₙ; and Δϕ is the phase changes from optical signal input to optical signal output generated by the non-linear optical device 128. The intensity function f includes optical amplifying, saturating, rectifying and attenuating, and/or a combination of these functions, or any types of similar function to serve as optical input to optical output nonlinear activation functions. A few criteria would need in device 128. First, the optical nonlinear activation may need active feedback control to emulate the arbitrary layers matrices and to classify and predict performance. Examples of active control are bias current, voltage and/or phase tuning operation for activation functions in optical amplifying, attenuating and saturating. Second, low electrical power consumption in each optical nonlinear device is typically determined by the biasing current times the biasing voltage applied on the nonlinear device 128, and it is desired to stay low to reach power efficiency in ONNs. Third, various optical nonlinear functions f can be implemented in the optical domain with associated IC driver and firmware algorithms, similar to various CMOS IC-based nonlinear functions.

For example, if the signal output 126 level represents 8 bits, it may be desirable for the nonlinear optical device 128 to clean up the representation of a low bit to 0, and a high bit to be put into the upper limits as a saturation function. This will enhance the performance of optical signal output to proceed to the next layer in the linear functions of the various optical matrix multipliers.

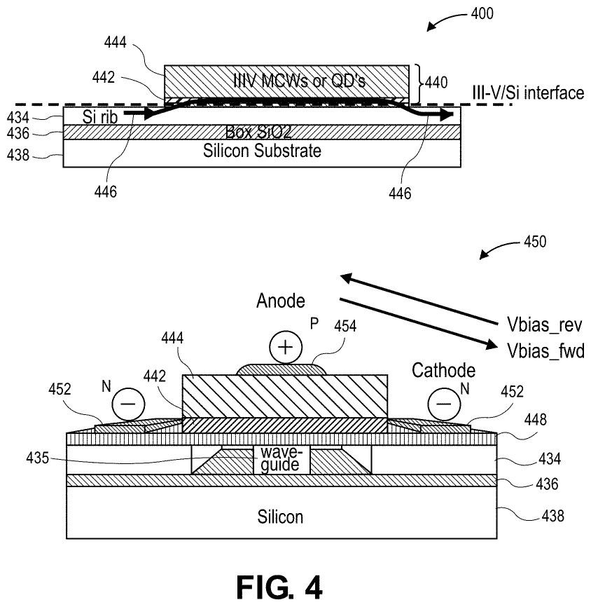

FIG. 2 illustrates examples of a nonlinear optical device with and without a carrier injection forward biased diode, in accordance with various embodiments. An example nonlinear optical device 200 of FIG. 2 (similar to 128 of FIG. 1) includes an amplifier 230, which includes a gain medium 238. The gain medium 238 receives light in the form of optical signal 232 into waveguide 234. The waveguide is coupled with a first taper 236 into the gain medium 238 that is described further below. Amplified light exits from the gain medium through the second taper 240 as optical signal 242. With respect to diagram 200, the optical power of the output 242 is equal to a power of the optical input 232, plus a gain factor G. The amplifier 230 components are described in more detail with respect to FIG. 4 below.

Gain medium 238 may be bonded on the silicon photonics waveguide 234 to provide nonlinear output power change with optical input power, in bias current vs voltage operation for activation functions in optical amplifying, attenuating and saturating. The gain medium has a gain which is highly nonlinear as a function of the input optical power and the unsaturated model gain. Since the gain depends on the input optical power, the gain medium is nonlinear. The nonlinearity occurs primarily due to gain saturation. When the gain medium operates in the linear regime where optical input power Pin is relatively low, the gain of the gain medium can linearly increase as the input optical power increases, leading to the output optical power Pout increase. Because the optical input power Pin increases relatively high when the gain medium operates in the non-linear saturation regime, the output optical power (Pₒᵤₜ) does not change relative to Pᵢₙ, where the saturated output power is defined as Pₛₐₜ. and described below in greater detail. Gain compression in the gain medium occurs primarily due to insufficient photons generated due to the stimulated recombination limited by the supply of free charge carriers to the active region. The saturated operating point of the gain medium can be operated as optical analogue of nonlinear-like Sigmoid or Tan h functions.

The operation of the gain medium may be described by the following equation:

Pₒᵤₜ=Pᵢₙ+G(Pᵢₙ)

where Pin is the input optical power to the gain medium, and Pₒᵤₜ is the output power at the end of the gain medium. The gain medium has a gain G and it depends on the input optical power to the gain medium G(Pᵢₙ). The optical power can be measured in dBm, and Gain G can be measured in dB. Bias-voltage control of the amplifier 230 nonlinear functions may result in very different optical output power levels. If the light power is too low, or on-chip loss is too high, the amplifier 230 may exhibit a combination of nonlinear amplification behavior, and begin to behave like a sigmoid function.

In a design for nonlinear gain medium, there are two key parameters. The first, gain factor G, which itself is highly nonlinear. The second is saturation power Pₛₐₜ for input optical power and output optical power. For a given layer of an ONN they can be customized for in design gain-medium geometry, for example III-V layer cavity length, width, gain medium mesa structure, epitaxial layer stack, and/or geometry may form sigmoid-like optical nonlinear functions.

$$G ∝ {e}^{[ {Γ}_{a} \dot{g} - α ] L}$$

$${P}_{sat} ∝ \frac{{A}_{eff} h / 2 πω}{{a}_{N} {τ}_{s}}$$

In the equation for G, g is the material gain of the active region Γₐ is the mode confinement factor of the active region, α is the modal loss, equal to the loss of each region weighted by its mode confinement factor. L is the length of gain medium. In the equation for Pₛₐₜ, A_{eff} is an effective area of the optical mode, a_{N} is the differential gain, and τ_{S} is a recombination time.

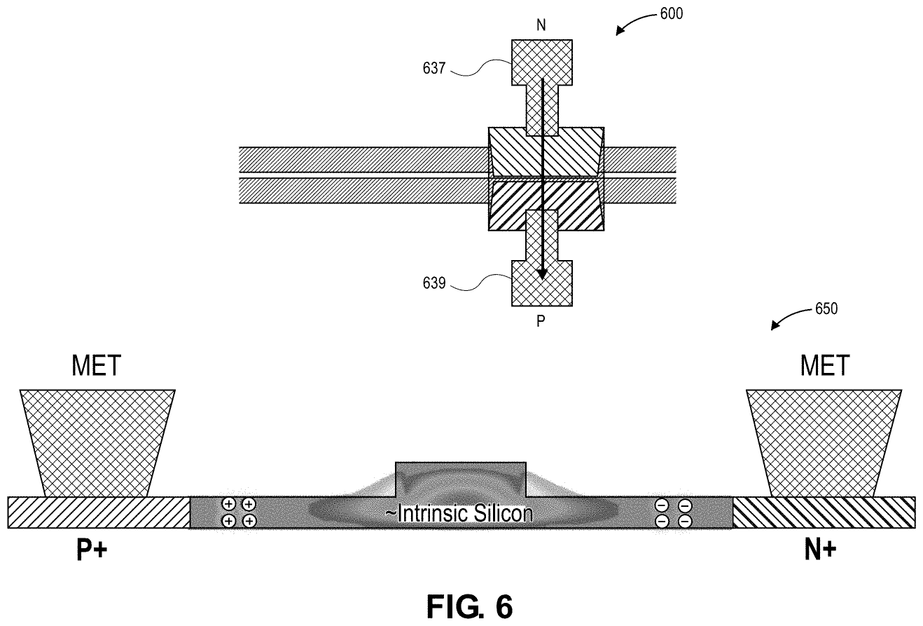

An example nonlinear optical device 250 (similar to 128 of FIG. 1) includes the amplifier 230 and gain medium 238, in conjunction with a carrier injection diode 260. In embodiments, the carrier injection diode 260 may be implemented as a free-carrier injection forward biased PIN diode. The carrier injection diode 260 receives an optical signal through waveguide 262, applies a nonlinear function to the optical signal, which exits as optical signal 264. With respect to diagram 250, the optical power of the output 264 is equal to a power of the optical input 232 plus the gain “G,” minus the effect of the nonlinear function implemented by the carrier injection diode 260. Details of carrier injection diode 260 are described in more detail in FIG. 6.

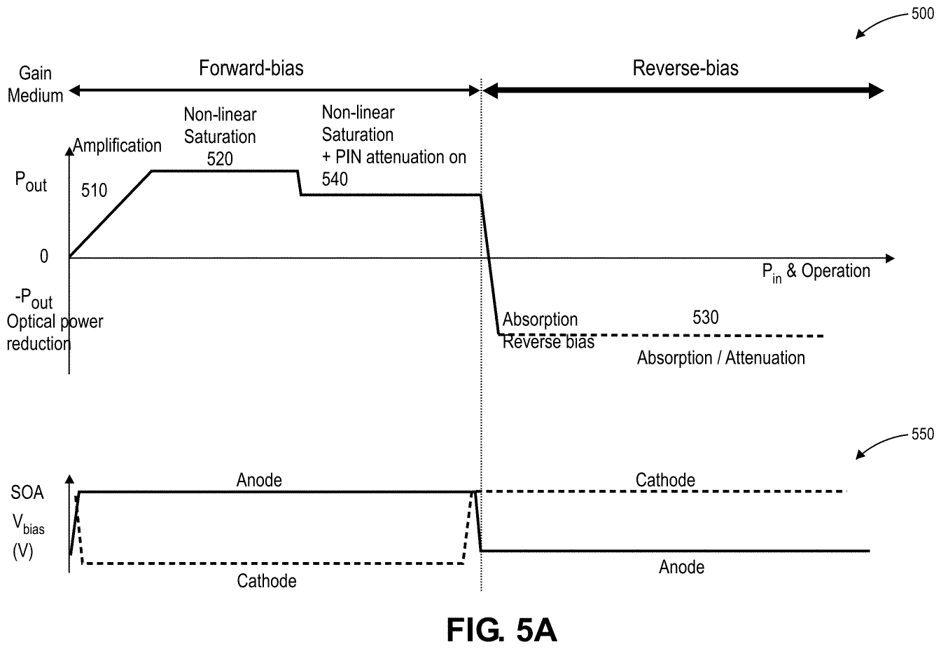

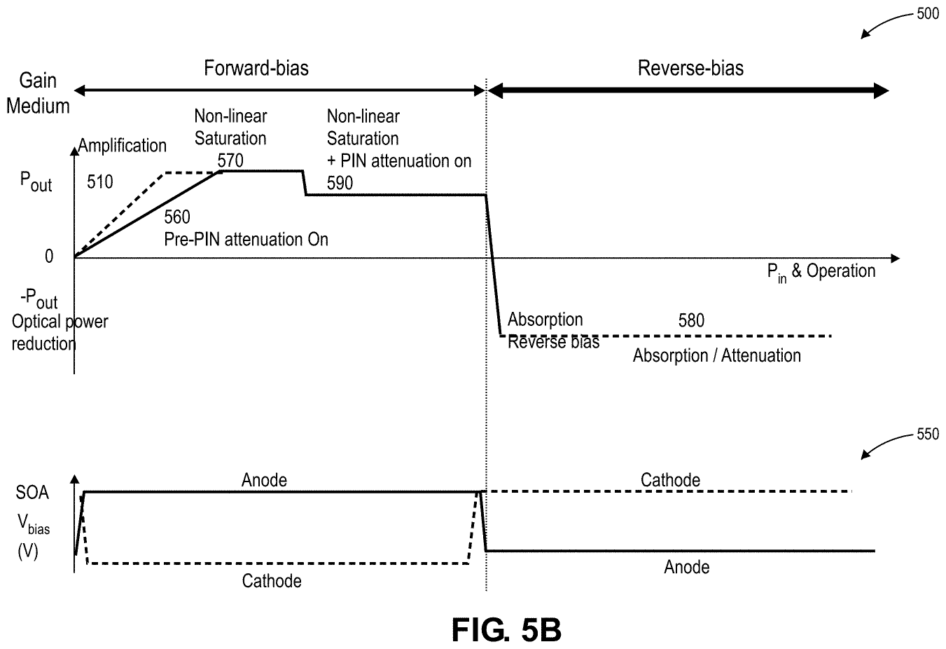

Alternatively, the carrier injection diode 260 can also be added before the gain medium 238 (as shown in the nonlinear optical device 270, similar to 128 of FIG. 1) to provide the input optical power control, and thus to adjust the nonlinear regimes between the linear amplifying states and the saturating states. A combination of pre- and post-PIN diodes provide various non-linear function regimes and the saturated operating points, as further discussed in reference to FIGS. 5A and 5B. The PIN diodes are turned on only as needed. G as a function of the unsaturated modal gain and the input optical power.

Since the amplifier gain depends on the input power, the amplifier is nonlinear. The nonlinearity is due to gain saturation. When input optical power is less than Pₛₐₜ, the amplifier gain G equals the unsaturated value G. As the input optical power Pin increases, the output optical power Pout also linear increases. As the output optical power becomes large enough to cause a significant reduction in the carrier density, and when the carrier density decreases, the gain G becomes saturated, then output optical power Pout is nearly not changing with the increasing input optical power. The add-on PIN pre- and post-diode provide the extra control of both the input optical power as well as the output optical power.

As shown, a free-carrier injection forwarded biased PIN diode 260 is added to enhance nonlinear activation functions in light attenuation. As a result of the edition of the carrier injection diode 260, the power function is:

Pₒᵤₜ=Pᵢₙ−e^{-(Δα}^{ₑ}^{+Δα}^{ₕ}^{)*L}+G(Pᵢₙ)

where Pᵢₙ, Pₒᵤₜ and G(Pᵢₙ) are defined as the above equations. Δαₑ and Δαₕ are the electrons and holes carrier-induced electro-absorption propagation loss coefficient expressed in cm⁻¹, respectively. L is the propagation distance along the free carrier-injection diode in waveguide expressed in cm. The carrier-induced electro-absorption propagation loss by the factor of exp (−Δα*L) is expressed in optical power loss in dB. The optical power is measured in dBm, and gain G(Pᵢₙ) is measured in dB, in embodiments.

In embodiments, a quantum well or a quantum dot gain medium may be used for highly efficient optical nonlinear activation functions and/or devices. This function is described in more detail for amplifier 230 in reference to FIG. 4, and for carrier injection diode 260 in reference to FIG. 6.

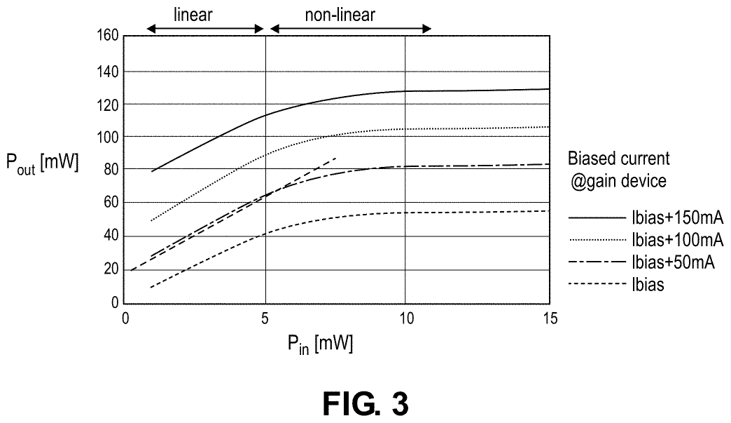

FIG. 3 illustrates a graph with example input and output power characteristics of an optical nonlinear device of FIG. 2, in accordance with various embodiments. In particular, FIG. 3 shows the measured data as described above in reference to FIG. 2. As shown, the response with the output power is clipped at high power, like a sigmoid function. Specifically, when the gain medium is operating in the saturation regime, changes in the input power may not lead to significant changes in the output power. For example, as shown in FIG. 3, when the input power Pin operates in a range from 0 to approximately 5 mW, the output of the optical nonlinear device is substantially linear. When the input power Pin operates in a range from that is higher than approximately 5 mW (e.g., 5 to 15 mW), the output of the optical nonlinear device is substantially nonlinear. Thus, this unique property of saturated gain medium provides the “clipped” output power (e.g., substantially nonlinear output Pout corresponding to the range 5 to 15 mW shown in FIG. 3), which is used to design the non-linear activation function fin of FIG. 1. In addition, the saturated output power Pₛₐₜ increases as the gain medium biasing current increases, which depends on the input optical power. This feature may be used to design the various non-linear functions f, in combination with the added PIN absorption diodes.

FIG. 4 illustrates various diagrams of an example nonlinear optical device, in accordance with various embodiments. Diagram 400 shows a side view of the main part of the amplifier 238 of FIG. 2. In embodiments, the amplifier may be formed on a silicon-on-insulator (SOI) platform where the waveguide 435 can be provided in silicon (Si). Accordingly, the amplifier shown in diagram 400 may be formed in a semiconductor layer (e.g., including silicon or other silicon-based material. Diagram 400 includes a silicon rib 434, that includes a waveguide 435 of diagram 450, that is on top of a buried oxide (BOX) layer 436 that is disposed onto a silicon substrate 438. A III-V quantum well and/or quantum dot structure 440 is coupled with the silicon rib 434 to form a gain medium. The gain medium includes a quantum well layer 442 that is coupled with a III-V structure 444.

During operation light signal 446 flows from the silicon rib 434, gets drawn up into the quantum well layer 442 next to the III-V material 444, and then subsequently flows back down into the silicon rib layer 434. During this process, amplification of the light occurs. In embodiments, the III-V material 444 acts as a semiconductor amplifier in the forward bias and acts as absorption as a attenuating in the reverse bias.

Attributes of the structures of the quantum well layer 442 and the III-V material 444 may be changed in order to affect the amount of amplification, including whether the amplification is linear or nonlinear. For example, lengths of the cavity in which the light 446 flows in the quantum well layer 442 may be shortened to make nonlinear amplification faster. By adjusting the quantum well layer 442 and the III-V material, the amplification range, saturation range, or saturation attenuation points may be adjusted. Note that if the amplification or intensity of the light 446 is too high, the light will become saturated and perform as a nonlinear function. In embodiments, the quantum well layer 442 may be a quantum dot.

Diagram 450 shows a cross-section perpendicular to the silicon rib 434, and includes the silicon substrate 438, the box layer 436, and the silicon rib 434. The waveguide 435 is shown on top of the box layer 436, and is surrounded by channels of air or silicon oxide between the waveguide 435 and the rest of the silicon rib 434. In some embodiments, the semiconductor layer 435 can be provided on high index waveguide platforms, such as silicon nitride (Si3N4) waveguide-buried oxide (BOX)-Si substrate, or silicon oxynitride (SiON) waveguide-BOX-Si substrate, higher index delta silicon oxide (SiOx) waveguide-BOX-Si substrate.

In embodiments, the gain material of the III-V structure 444 may include III-V compounds. For example, the gain material may include a combination of elements in group III of the periodic table (e.g., aluminum, gallium, indium, etc.) and elements in group V of the periodic table (e.g., phosphorous, arsenic, antimony, etc.) For example, the III-V compounds may include gallium nitride (GaN), gallium arsenide (GaAs), indium phosphide (InP), aluminum arsenide (AlAs), various combinations of the elements or compounds (e.g., InGaAsP, InAlGaAs, etc.), or some other III-V compound. I n some embodiments, the gain material may include glass, ceramic, or some other material. In some embodiments the gain material may include various layers of the above compounds or some other type of gain material. Any other materials suitable for generation of the non-linear function in the gain medium may be used.

On top of the waveguide 435 and the silicon rib 434 is a III-V layer 448. In embodiments, a cathode 452 may be applied to the III-V layer 448, and an anode 454 applied to the top of III-V layer 444.

In embodiments, a forward bias or a reverse bias may be applied to the layer 448, and an anode 454 may be provided to the top of the II-V layer 454. In embodiments, the amplifier 400 may perform the function of amplifying light when a voltage is applied to the cathode 452 that is less than a voltage applied to the anode 454, creating a forward bias. The amplifier 400 may perform the function of absorbing light when a voltage is applied to the anode 454 that is greater than a voltage applied to the cathode 452, creating a reverse bias.

FIGS. 5A and 5B illustrate examples of forward bias and reverse bias effects applied to a nonlinear optical device, in accordance with various embodiments. In the nonlinear devices (e.g., 250 or 270 of FIG. 2) operated as shown in FIGS. 5.A and 5.B, the extra PIN diodes (e.g., 260) are turned on during the gain medium forward bias operations for power amplifying and saturating. Optionally the PIN attenuation can be turned on during the gain medium reverse biasing as an absorption photodiode effect.

In FIG. 5.A, forward bias voltage is applied to the gain medium for an optical power amplification (510) and non-linear gain saturation (520). Turning on the PIN diode (e.g., 260 in the device 250 of FIG. 2) provides for the post-PIN with forward bias carrier injection absorption for additional optical power attenuation (540). This way the output optical power can be provided based on the desired non-linear functions f. Reverse bias voltage can be further applied to the gain medium for optical power absorption as a photodiode effect (530). During the reversed bias, the PIN diode may not be necessary and/or could be turned on optionally.

In FIG. 5.B, the same scheme applies. The pre-PIN diode (e.g., 260 in the device 270) can be turned on to adjust the input optical power level launched into the gain medium 238, leading to the controllable linear and nonlinear regimes from 510 to 560.

FIG. 6 illustrates various example diagrams of a carrier injection forward based diode used in a nonlinear optical device, in accordance with various embodiments. Carrier injection diode 600, which may be similar to carrier injection diode 260 of FIG. 2, is a structure that interacts with optical signals on waveguide 634, which may be similar to waveguide 234 of FIG. 2. Embodiments of the carrier injection diode 600 may include a carrier injection forward biased PIN diode. In embodiments, the diode may include an N junction 637 and a P junction 639.

Turning back to FIG. 2, it is the combination of the amplifier 230 of FIG. 2, and the carrier injection diode 600 that is able to control the intensity and the gain of the optical signals from layer to layer of ONN 102, and eventually to PDA 114 of FIG. 1.

Some example applications of the nonlinear optical devices in ONN are described below. Specifically, FIG. 7 below provides example configurations of the layer 104 and specifically matrices 118, 120, and 122 of FIG. 1. As described in reference to FIG. 1, the nonlinear optical amplifier 124 (or device 128) may be used in connection with the layer 104, described in detail in reference to FIG. 7.

FIG. 7 illustrates an example matrix multiplier that includes a plurality of 2×2 unitary directional optical matrices and an optical unitary matrix that includes a plurality of 2×2 unitary multi-mode interference (MMI) optical couplers, in accordance with other embodiments of the present disclosure. In embodiments, the optical unitary matrices are coupled together to form matrix multipliers having a plurality of n optical inputs and a plurality of n optical outputs. In embodiments, matrix multiplier 701 is an optical unitary matrix that includes a plurality of 2×2 unitary directional optical matrices 702 (e.g., similar or the same as photonic device 100 of FIG. 1) while matrix multiplier 703 includes a plurality of 2×2 unitary multi-mode interference (MMI) optical couplers 704.

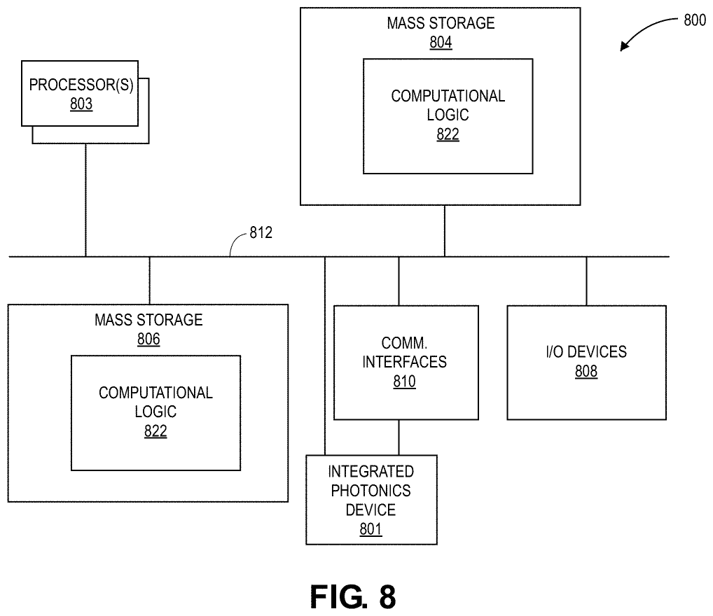

Note that for clarity, only one of 2×2 directional optical matrices 702 and one of 2×2 unitary multi-mode interference (MMI) optical couplers 704 is labeled. For matrix multiplier 701, a plurality of 2×2 directional optical matrices 702 are optically coupled together to receive an array of optical signal inputs at 705 in FIG. 8 and to linearly transform the plurality of optical signal inputs into an array of optical signal outputs 707. Similarly, for matrix multiplier 703, a plurality of unitary multi-mode interference (MMI) optical couplers 704 are coupled together to receive an array of optical signal inputs at 711 to linearly transform the plurality of optical signal inputs into an array of optical signal outputs 707.

Note that the array of optical signal inputs 707 for matrix multiplier 701 (and optical signal inputs 711 for matrix multiplier 703) include n optical inputs and n optical signal outputs where n=8. In embodiments, the matrix multipliers each include n (n−1)/2 2×2 unitary optical matrices (e.g., n (n−1)/2 2×2 optical matrices. Although n=8 in FIG. 7 for both matrix multiplier 701 and 703, it should be understood that 8 is only an example and n is any number of optical inputs and optical outputs suitable for an application. In embodiments, n is 2, 4, 8, 16, 32, 64, 128, or 256. It is further understood that couplings as in matrix multiplier 701 and 703 have been simplified in order to conceptually illustrate optical connections between 2×2 directional optical matrices 702 or unitary multi-mode interference (MMI) optical couplers 704. The matrix multiplier can have n optical inputs and m output outputs, n may be not equal to m where n, m=2, 3, 8, 16, 32, 64, 128 or 256, and it include n (m−1)/2 2×2 unitary optical matrices.

Accordingly, as described in connection with FIGS. 1-6, each of 2×2 directional optical matrices 702 and 2×2 unitary multi-mode interference (MMI) optical couplers 704 each include a first optical waveguide and a second optical waveguide coupled along an optical path. Furthermore, for the embodiments, a plurality of tunable optical phase shifters are included along the optical path of each of the first optical waveguide and the second optical waveguide in each of the plurality of 2×2 unitary optical matrices to phase shift an optical beam to linearly transform the array of optical signal inputs into the array of optical signal outputs.

Note that a tuning allows the modes of the first optical signal and the second optical signal interfere in the MM waveguide to output an optical signal at a power ratio that can be adjusted according to a U(2) matrix algebra.

FIG. 8 illustrates an example computing device provided with an ONN in accordance with various embodiments. More specifically, FIG. 8 illustrates an example computing device 800 suitable for use with an integrated photonics device 801 (e.g., similar to or the same as integrated photonics device 100 or ONN 102 of FIG. 1) in accordance with various embodiments as described herein. For example, integrated photonics device 801 can include an ONN integrated circuit (IC) including an array of light sources and an optical unitary matrix multiplier in a semiconductor substrate. In embodiments, a processor coupled to the ONN IC provides the ONN with the data to modulate onto the array of optical signal inputs to be transformed by the optical unitary matrix multiplier.

In embodiments, the device 801 (and/or computing device 800) may include or be used in general matrix multiplier (GEMM) or convolutional (CONV) neural network accelerators, heterogeneous artificial intelligence (AI) media inferencing accelerators, domain-specific machine-learning and deep learning accelerators (Neuro/Memory/inferencing/training), or data-centric neural network computing processors.

As shown, computing device 800 may include a one or more processors or processor cores 803 and memory 804. In some embodiments, the device 801 may be integrated with the processors 803. In embodiments, memory 804 may be system memory. For the purpose of this application, including the claims, the terms “processor” and “processor cores” may be considered synonymous, unless the context clearly requires otherwise. The processor 803 may include any type of processors, such as a central processing unit, a microprocessor, and the like. The processor 803 may be implemented as an integrated circuit having multi-cores, e.g., a multi-core microprocessor. The computing device 800 may include mass storage devices 806 (such as diskette, hard drive, volatile memory (e.g., dynamic random-access memory (DRAM), compact disc read-only memory (CD-ROM), digital versatile disk (DVD), and so forth). In general, memory 804 and/or mass storage devices 806 may be temporal and/or persistent storage of any type, including, but not limited to, volatile and non-volatile memory, optical, magnetic, and/or solid state mass storage, and so forth. Volatile memory may include, but is not limited to, static and/or dynamic random-access memory. Non-volatile memory may include, but is not limited to, electrically erasable programmable read-only memory, phase change memory, resistive memory, and so forth.

The computing device 800 may further include input/output (I/O) devices 808 (such as a display (e.g., a touchscreen display), keyboard, cursor control, remote control, gaming controller, image capture device, and so forth) and communication interfaces 810 (such as network interface cards, modems, infrared receivers, radio receivers (e.g., Bluetooth), and so forth). In some embodiments, the communication interfaces 810 may include or otherwise be coupled with integrated photonics device 801, as described above, in accordance with various embodiments.

The communication interfaces 810 may include communication chips that may be configured to operate the device 800 in accordance with a Global System for Mobile Communication (GSM), General Packet Radio Service (GPRS), Universal Mobile Telecommunications System (UMTS), High Speed Packet Access (HSPA), Evolved HSPA (E-HSPA), or Long-Term Evolution (LTE) network. The communication chips may also be configured to operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication chips may be configured to operate in accordance with Code Division Multiple Access (CDMA), Time Division Multiple Access (TDMA), Digital Enhanced Cordless Telecommunications (DECT), Evolution-Data Optimized (EV-DO), derivatives thereof, as well as any other wireless protocols that are designated as 3G, 4G, 5G, and beyond. The communication interfaces 810 may operate in accordance with other wireless protocols in other embodiments.

The above-described computing device 800 elements may be coupled to each other via system bus 812, which may represent one or more buses. In the case of multiple buses, they may be bridged by one or more bus bridges (not shown). Each of these elements may perform its conventional functions known in the art. In particular, memory 804 and mass storage devices 806 may be employed to store a working copy and a permanent copy of the programming instructions for the operation of integrated photonics device. The various elements may be implemented by assembler instructions supported by processor(s) 803 or high-level languages that may be compiled into such instructions.

The permanent copy of the programming instructions may be placed into mass storage devices 806 in the factory, or in the field, through, for example, a distribution medium (not shown), such as a compact disc (CD), or through communication interface 810 (from a distribution server (not shown)). That is, one or more distribution media having an implementation of the agent program may be employed to distribute the agent and to program various computing devices.

The number, capability, and/or capacity of the elements 808, 810, 812 may vary, depending on whether computing device 800 is used as a stationary computing device, such as a server computer in a data center, or a mobile computing device, such as a tablet computing device, laptop computer, game console, or smartphone. Their constitutions are otherwise known, and accordingly will not be further described.

For one embodiment, at least one of processors 803 may be packaged together with computational logic 822 configured to practice aspects of optical signal transmission and receipt described herein to form a System in Package (SiP) or a System on Chip (SoC).

In various implementations, the computing device 800 may comprise one or more components of a data center, a laptop, a netbook, a notebook, an ultrabook, a smartphone, a tablet, a personal digital assistant (PDA), an ultra mobile PC, a mobile phone, or a digital camera. In further implementations, the computing device 800 may be any other electronic device that processes data.

According to various embodiments, the present disclosure describes a number of examples.

Example 1 is an apparatus, comprising a waveguide to receive optical input; and a gain medium coupled with the waveguide, to amplify or attenuate the received optical input, to provide an output that is generated in a nonlinear manner in response to the optical input reaching saturation, wherein the nonlinearly generated output is to provide a nonlinear activation function for an optical neural network (ONN).

Example 2 is the apparatus of Example 1, further comprising an optical matrix multiplier of the ONN coupled with the waveguide, wherein an output of the optical matrix multiplier comprises the optical input to the waveguide.

Example 3 is the apparatus of Example 1, wherein the apparatus to provide the nonlinear activation function includes to provide at least one of: amplification, saturation, rectification, or attenuation of the optical input.

Example 4 is the apparatus of Example 1, wherein the gain medium includes a III/V material.

Example 5 is the apparatus of Example 4, wherein the gain medium is characterized by one or more parameters, wherein the parameters include a gain factor G, wherein the gain factor G is a non-linear parameter.

Example 6 is the apparatus of Example 1, wherein the gain medium includes a multiple quantum well (MQW).

Example 7 is the apparatus of Example 6, wherein the gain medium comprises a quantum dot gain medium.

Example 8 is the apparatus of Example 1, further comprising a carrier injection diode coupled with the gain medium, to provide attenuation control to the output.

Example 9 is the apparatus of Example 1, wherein the carrier injection diode comprises a PIN diode.

Example 10 is the apparatus of Example 1, wherein the apparatus comprises a nonlinear optical device.

Example 11 is the apparatus of Example 1, wherein the apparatus is integrated in an ONN integrated circuit.

Example 12 is an apparatus for an optical neural network (ONN), comprising: an optical matrix multiplier provided in a semiconductor substrate to receive an array of optical signal inputs and to linearly transform the plurality of optical signal inputs into an array of optical signal outputs; a nonlinear optical device coupled with the optical matrix multiplier, to receive the optical signal outputs from the optical matrix multiplier, and to provide a first optical output that is generated in a linear manner in response to the optical signal outputs of the matrix multiplier operating in a first power range, and to provide a second optical output that is generated in a nonlinear manner in response to the optical signal outputs of the optical matrix multiplier operating in a second power range, wherein the second power range has a higher power limit than the first power range, wherein the nonlinearly generated optical output of the nonlinear optical device is to provide a nonlinear activation function for the ONN.

Example 13 is the apparatus of claim 12, further comprising: an array of light sources provided in the semiconductor substrate to generate an array of light signals; and a plurality of optical modulators coupled to the array of light sources in the semiconductor substrate to modulate data onto the light signals to generate the array of optical signal inputs, to be provided to the optical matrix multiplier.

Example 14 is the apparatus of Example 13, wherein the optical matrix multiplier is coupled with the plurality of optical modulators.

Example 15 is the apparatus of Example 12, wherein the nonlinear optical device includes: a waveguide to receive the optical signal outputs from the optical matrix multiplier; and a gain medium coupled with the waveguide, to provide the first and second optical outputs.

Example 16 is the apparatus of Example 13, wherein the semiconductor substrate is a single semiconductor substrate, wherein the array of light sources, the plurality of optical modulators, the optical unitary matrix multiplier, and the nonlinear optical device are heterogeneously integrated in the single semiconductor substrate.

Example 17 is a system, comprising: an optical neural network (ONN) integrated circuit (IC), including: an optical matrix multiplier provided in a semiconductor substrate to receive an array of optical signal inputs and to linearly transform the plurality of optical signal inputs into an array of optical signal outputs; and a nonlinear optical device coupled with the optical matrix multiplier, to receive the optical signal outputs from the optical matrix multiplier, and to provide an optical output that is generated in a nonlinear manner in response to the optical signal outputs the optical matrix multiplier reaching saturation, wherein the nonlinearly amplified generated output of the nonlinear optical device is to provide a nonlinear activation function for the ONN; and a processor coupled to the ONN IC to provide the ONN with data to modulate onto the array of optical signal inputs to be linearly transformed by the optical matrix multiplier.

Example 18 is the system of Example 17, wherein the ONN IC further includes: an array of light sources provided in the semiconductor substrate to generate an array of light signals; and a plurality of optical modulators coupled to the array of light sources in the semiconductor substrate to modulate data onto the light signals to generate the array of optical signal inputs, to be provided to the optical matrix multiplier.

Example 19 is the system of Example 18, wherein the nonlinear optical device includes: a waveguide to receive the optical signal outputs from the optical matrix multiplier; and a gain medium coupled with the waveguide, to provide the optical output that is generated in the nonlinear manner in response to the optical signal outputs of the optical matrix multiplier reaching saturation.

Example 19 is the system of Example 18, wherein the processor is included in one of: general matrix multiplier (GEMM) neural network accelerator, a convolutional (CONV) neural network accelerator, a domain-specific machine-learning accelerator, or a deep learning accelerator.

Various embodiments may include any suitable combination of the above-described embodiments including alternative (or) embodiments of embodiments that are described in conjunctive form (and) above (e.g., the “and” may be “and/or”). Furthermore, some embodiments may include one or more articles of manufacture (e.g., non-transitory computer-readable media) having instructions, stored thereon, that when executed result in actions of any of the above-described embodiments. Moreover, some embodiments may include apparatuses or systems having any suitable means for carrying out the various operations of the above-described embodiments.

The above description of illustrated implementations, including what is described in the Abstract, is not intended to be exhaustive or to limit the embodiments of the present disclosure to the precise forms disclosed. While specific implementations and examples are described herein for illustrative purposes, various equivalent modifications are possible within the scope of the present disclosure, as those skilled in the relevant art will recognize.

These modifications may be made to embodiments of the present disclosure in light of the above detailed description. The terms used in the following claims should not be construed to limit various embodiments of the present disclosure to the specific implementations disclosed in the specification and the claims. Rather, the scope is to be determined entirely by the following claims, which are to be construed in accordance with established doctrines of claim interpretation.

1. An apparatus, comprising:
a waveguide to receive optical input; and
a gain medium coupled with the waveguide, to amplify or attenuate the received optical input, to provide an output that is generated in a nonlinear manner in response to the optical input reaching saturation, wherein the nonlinearly generated output is to provide a nonlinear activation function for an optical neural network (ONN).

2. The apparatus of claim 1, further comprising an optical matrix multiplier of the ONN coupled with the waveguide, wherein an output of the optical matrix multiplier comprises the optical input to the waveguide.

3. The apparatus of claim 1, wherein the apparatus to provide the nonlinear activation function includes to provide at least one of: amplification, saturation, rectification, or attenuation of the optical input.

4. The apparatus of claim 1, wherein the gain medium includes a III/V material.

5. The apparatus of claim 4, wherein the gain medium is characterized by one or more parameters, wherein the parameters include a gain factor G, wherein the gain factor G is a non-linear parameter.

6. The apparatus of claim 1, wherein the gain medium includes a multiple quantum well (MQW).

7. The apparatus of claim 6, wherein the gain medium comprises a quantum dot gain medium.

8. The apparatus of claim 1, further comprising a carrier injection diode coupled with the gain medium, to provide attenuation control to the output.

9. The apparatus of claim 1, wherein the carrier injection diode comprises a PIN diode.

10. The apparatus of claim 1, wherein the apparatus comprises a nonlinear optical device.

11. The apparatus of claim 1, wherein the apparatus is integrated in an ONN integrated circuit.

12. An apparatus for an optical neural network (ONN), comprising:
an optical matrix multiplier provided in a semiconductor substrate to receive an array of optical signal inputs and to linearly transform the plurality of optical signal inputs into an array of optical signal outputs; and
a nonlinear optical device coupled with the optical matrix multiplier, to receive the optical signal outputs from the optical matrix multiplier, and to provide a first optical output that is generated in a linear manner in response to the optical signal outputs of the matrix multiplier operating in a first power range, and to provide a second optical output that is generated in a nonlinear manner in response to the optical signal outputs of the optical matrix multiplier operating in a second power range, wherein the second power range has a higher power limit than the first power range, wherein the nonlinearly generated optical output of the nonlinear optical device is to provide a nonlinear activation function for the ONN.

13. The apparatus of claim 12, further comprising:
an array of light sources provided in the semiconductor substrate to generate an array of light signals; and
a plurality of optical modulators coupled to the array of light sources in the semiconductor substrate to modulate data onto the light signals to generate the array of optical signal inputs, to be provided to the optical matrix multiplier.

14. The apparatus of claim 13, wherein the optical matrix multiplier is coupled with the plurality of optical modulators.

15. The apparatus of claim 12, wherein the nonlinear optical device includes:
a waveguide to receive the optical signal outputs from the optical matrix multiplier; and
a gain medium coupled with the waveguide, to provide the first and second optical outputs.

16. The apparatus of claim 13, wherein the semiconductor substrate is a single semiconductor substrate, wherein the array of light sources, the plurality of optical modulators, the optical unitary matrix multiplier, and the nonlinear optical device are heterogeneously integrated in the single semiconductor substrate.

17. A system, comprising:
an optical neural network (ONN) integrated circuit (IC), including:
an optical matrix multiplier provided in a semiconductor substrate to receive an array of optical signal inputs and to linearly transform the plurality of optical signal inputs into an array of optical signal outputs; and
a nonlinear optical device coupled with the optical matrix multiplier, to receive the optical signal outputs from the optical matrix multiplier, and to provide an optical output that is generated in a nonlinear manner in response to the optical signal outputs of the optical matrix multiplier reaching saturation, wherein the nonlinearly amplified generated output of the nonlinear optical device is to provide a nonlinear activation function for the ONN; and
a processor coupled to the ONN IC to provide the ONN with data to modulate onto the array of optical signal inputs to be linearly transformed by the optical matrix multiplier.

18. The system of claim 17, wherein the ONN IC further includes:
an array of light sources provided in the semiconductor substrate to generate an array of light signals; and
a plurality of optical modulators coupled to the array of light sources in the semiconductor substrate to modulate data onto the light signals to generate the array of optical signal inputs, to be provided to the optical matrix multiplier.

19. The system of claim 18, wherein the nonlinear optical device includes:
a waveguide to receive the optical signal outputs from the optical matrix multiplier; and
a gain medium coupled with the waveguide, to provide the optical output that is generated in the nonlinear manner in response to the optical signal outputs of the optical matrix multiplier reaching saturation.

20. The system of claim 18, wherein the processor is included in one of: general matrix multiplier (GEMM) neural network accelerator, a convolutional (CONV) neural network accelerator, a domain-specific machine-learning accelerator, or a deep learning accelerator.
